(19) United States
(12) Patent Application Publication
(10) Pub. No.: US 2005/0058908 A1
(43) Pub. Date: Mar. 17, 2005

(54) Secondary cell

(75) Inventors: Naoki Imachi, Hyogo (JP); Seiji Yoshimura, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/941,852

(22) Filed: Sep. 16, 2004

(30) Foreign Application Priority Data
Sep. 17, 2003 (JP) 2003-325019

(51) Int. Cl. H01M 4/64; H01M 2/26

(52) U.S. Cl. 429/233; 429/94; 429/211; 429/161

(57) ABSTRACT

The present invention provides a secondary cell having a rolled-up electrode unit accommodated into an outer body. While an uncoated portion of a positive electrode projects at one of axially opposite ends of the rolled-up electrode unit to form a projection, an uncoated portion of a negative electrode projects at the other end to form a projection. Each of the two projections is formed with a current collecting auxiliary portion obtained by bringing each pair of the uncoated portions into ultrasonic pressing contact with each other. An electrode tab is attached to each of the positive electrode and the negative electrode. Outer ends of the two electrode tabs project outward beyond the outer body. The two outer ends provide a pair of positive and negative electrode terminal portions.

### BACKGROUND OF THE INVENTION

1. Field of the Invention

The present invention relates to secondary cells, such as lithium ion secondary cells or lithium polymer secondary cells, which comprise an electrode unit accommodated into an outer body and serving as an electricity generating element and which are adapted to deliver power generated by the electrode unit via a pair of positive and negative electrode terminal portions to the outside.

2. Description of Related Art

In recent years, attention has been directed to lithium ion secondary cells or lithium polymer secondary cells having a high energy density for use as a power source for portable electronic devices. Serving as a small-sized cell for use as a power source for portable telephone or the like, rectangular lithium ion secondary cells exhibit more excellent cell characteristics than the lithium polymer secondary cells. Accordingly, by utilizing characteristics of the lithium polymer secondary cells that the formation of the cell has high flexibility, the lithium polymer secondary cells having a greater capacity and a greater area are being developed.

The lithium polymer secondary cells heretofore known include lithium polymer secondary cells of superposed-layers type comprising as superposed in layers a positive and a negative electrodes each in the form of a sheet and each having an electrode tab projecting therefrom, and a separator interposed between the electrodes (see JP-A No. 2003-17112, JP-A No. 2000-12085). With the lithium polymer secondary cells of superposed-layers type, a plurality of electrode tabs projecting from each of a positive electrode and a negative electrode are bound together to provide electrode terminal portions, through which power is delivered to the outside. Thus whereas the lithium polymer secondary cells of superposed-layers type exhibit high electrode characteristics, it is difficult to superpose a plurality of sheets of positive electrodes, separators, and negative electrodes as aligned with high accuracy in production steps, entailing the problem of low productivity.

Lithium polymer secondary cells of rolled-up type have been developed as shown in FIGS. 11 and 12. The lithium polymer secondary cell comprises an outer body 11 which is formed by a laminate sheet comprising two resin layers and an aluminum layer interposed between the two resin layers, a rolled-up electrode unit 4 which is accommodated into the outer body 11, and two electrode tabs 92, 93 which project from an upper end of the outer body 11 and which is connected to a pair of electrodes 41, 43. A pair of electrode terminal portions 20, 30 are formed by outer ends of the two electrode tabs 92, 93, respectively. From the pair of electrode terminal portions 20, 30 power generated by the rolled-up electrode unit 4 can be delivered to the outside.

The rolled-up electrode unit 4 comprises a positive electrode 41, separator 42, and negative electrode 43, which are each in the form of a strip. The positive and negative electrodes 41, 43 are lapped over respective separators displaced from the separator 42 widthwise thereof, and rolled up into a spiral form. The rolled-up electrode unit 4, in its entirety, has a flat shape formed perpendicularly to its winding axis. The positive electrode 41 comprises a portion coated with the positive electrode active substance 44 and a portion not coated with the substance 44. The uncoated portion is formed along an edge of a current collector 45, and is formed at a position for the electrode tab 92 on the side of the positive electrode to be attached to. The negative electrode 43 has a portion coated with the negative electrode active substance 46 and a portion not coated with the substance 46. The uncoated portion is formed along an edge of a current collector 47, and is formed at a position for the electrode tab 93 on the side of the negative electrode to be attached to.

With the lithium polymer secondary cell, merely lapping over and rolling up the positive electrode 41, separator 42, and negative electrode 43 provides the electrode unit wherein the positive electrode 41 and the negative electrode 43 are lapped over and opposed to each other as superposed in layers with the separator 42 interposed between the electrodes, hence high productivity.

Further, for the lithium polymer secondary cell shown in FIG. 11 to give an increased cell capacity, it is effective to increase the area of the coated portion by increasing a longitudinal length (electrode length) of the positive electrode 41 and the negative electrode 43. However, because each electrode of the rolled-up electrode unit 4 of the lithium polymer secondary cell has only one electrode tab attached thereto, increasing the electrode length makes longer a current path for current generated in an area far from the electrode tab to flow to the electrode tab. This increases electric resistance through the current path, entailing the problem of reduced current collection efficiency performed by the electrode tab.

Therefore, a plurality of electrode tabs are attached to each electrode at a specified interval and end portions of the electrode tabs are bound together for each electrode. In this case a plurality of electrode tabs need be aligned for each electrode as shown in FIG. 14. However, because the electrode tabs are respectively attached to each electrode before the pair of electrodes 41, 43 are rolled up, there arises the problem that difficulty is encountered in rolling up the electrodes 41, 43 so that the plurality of electrode tabs are aligned for each electrode. Furthermore the electrode tabs need be attached to the uncoated portions of the electrode, so that each electrode need be formed with the plurality of uncoated portions, whereby the coated portion has reduced area to entail the problem of reduced cell characteristics.

### SUMMARY OF THE INVENTION

An object of the present invention is to provide a secondary cell which is adapted to improve current collection efficiency without an increase in the number of electrode tabs.

The present invention provides a secondary cell having a rolled-up electrode unit 4 comprising a positive electrode 41 and negative electrode 43 which are each in the form of a strip and which are rolled up into a spiral form with a separator 42 interposed between the electrodes, the rolled-up electrode unit 4 being accommodated into an outer body 11, the positive electrode 41 and the negative electrode 43 each comprising a current collector in the form of a strip and an active substance applied to a surface of the current collector, the rolled-up electrode unit 4 generating power to be delivered to the outside via a pair of positive and negative electrode terminal portions 20, 30.

Each of the positive electrode 41 and the negative electrode 43 has an uncoated portion which is not coated with the active substance and which is formed at one of axially opposite ends of the electrode unit and which is formed along an edge of the current collector. The rolled-up electrode unit 4 has a projection 48 at one end of the axially opposite ends of the electrode unit and which is formed by the uncoated portion of the positive electrode 41 projecting therefrom. The rolled-up electrode unit 4 has a projection 48 at the other end and which is formed by the uncoated portion of the negative electrode 43 projecting therefrom. Each of the projections 48 is provided with a current collecting auxiliary portion 5 formed by joining to each other each of the adjacent uncoated portions. The rolled-up electrode unit 4 comprises a pair of electrode tabs 2, 3 each in the form of a strip. A base end of the electrode tab 2 is connected to the positive electrode 41 while a base end of the electrode tab 3 is connected to the negative electrode 43. A pair of outer end portions of the electrode tabs 2, 3 extend to the outside through the outer body 11. The pair of outer end portions forms a pair of positive and negative electrode terminal portions 20, 30, respectively.

With the secondary cell of the present invention, each electrode of the rolled-up electrode unit 4 is formed with a first current path to the electrode tab not through the current collecting auxiliary portion 5 and a second current path to the electrode tab through the current collecting auxiliary portion 5. Current generated by the electrodes flows to the electrode tab through the first current path and second current path. At this time almost all of the current generated in an area far from the electrode tab will flow to the electrode tab via the second current path having low electric resistance because the second current path becomes extremely shorter than the first current path. Thus internal resistance of the cell of the present invention is smaller than that of the conventional cell merely formed with the first current path having great resistance, whereby high current collection efficiency can be achieved.

Stated specifically, the rolled-up electrode unit 4 has a flat shape formed perpendicularly to its winding axis. The outer body 11 is formed by a laminate sheet comprising two resin layers and a metal layer interposed between the resin layers. Each of the positive electrode 41 and the negative electrode 43 is formed with an uncoated rolled-up portion 410 not coated with the active substance at an end portion longitudinally of the current collector. The electrode tab has its base end connected to the uncoated rolled-up portion 410 and projects perpendicularly to the winding axis of the rolled-up electrode unit 4.

In assembly steps of the secondary cell having the specific construction, the laminate sheet to form the outer body is folded in half, the rolled-up electrode unit 4 is accommodated into the folded laminate sheet, and opposed overlap surfaces are sealed off, respectively, provided at three sides of the folded laminate sheet. At this time the rolled-up electrode unit 4 is accommodated in a posture such that the electrode tab extends through the opposed overlap surface provided at the central side, and the opposed overlap surface provided at the central side and another opposed overlap surface provided at another side are sealed off, respectively. Thereafter the remaining opposed overlap surface provided at the other side is opened to pour electrolyte into the opening and the opening is sealed off as a last step.

In the assembly steps described the electrolyte is poured into the opening axially of the rolled-up electrode unit 4. A clearance formed between the separator 42 and each of the positive and negative electrodes 41, 43 at the end portion of the rolled-up electrode unit 4 has an opening axially of the rolled-up electrode unit 4, so that the electrolyte can easily penetrate into the rolled-up electrode unit 4 via the clearance to impregnate the rolled-up electrode unit 4, in its entirety, with the electrolyte in a short period of time.

Stated further specifically, the current collecting auxiliary portion 5 is formed by bringing each pair of the adjacent uncoated portions into ultrasonic pressing contact with each other. According to the specific construction, a joint portion wherein each of the adjacent uncoated portions is joined to each other has sufficiently reduced electric resistance.

Stated furthermore specifically, the current collecting auxiliary portion 5 comprises a current collection auxiliary pin 51 extending through the projection 48 of the rolled-up electrode unit 4. The current collection auxiliary pin 51 comprises a barrel portion 52 extending through the projection 48 and a pair of pressing portions 53, 53 projecting from opposite ends of the barrel portion 52. The pair of pressing portions 53, 53 hold the projection 48 by pressure between its opposite sides. Owing to the holding pressure, each pair of the adjacent uncoated portions is in pressing contact with each other. According to the specific construction, the barrel portion 52 of the current collection auxiliary pin 51 extends through the projection 48 of the rolled-up electrode unit 4 and the pressing portions 53, 53 hold the projection 48 by pressure between its opposite sides, so that there is no likelihood that the current collection auxiliary pin 51 will be removed from the projection 48 even when a great impact is applied thereto from the outside, to reliably ensure the state wherein each pair of the adjacent uncoated portions is held in pressing contact with each other.

The construction of the current collecting auxiliary portion 5 comprising the current collection auxiliary pin 51 can be replaced by a current collecting auxiliary member 54 for holding the projection 48 of the rolled-up electrode unit 4 between its opposite sides. The current collecting auxiliary member 54 comprises a male lug 55 and a female lug 56 which are fittable to each other with the projection 48 interposed therebetween. The pressing force applied by the male lug 55 and the female lug 56 causes each pair of the adjacent uncoated portions to be in pressing contact with each other. With the current collecting auxiliary portion 5, the male lug 55 and the female lug 56 providing the current collecting auxiliary member 54 are fitted to each other to thereby fix the lugs 55, 56 to the projection 48 of the rolled-up electrode unit 4. Therefore welding is not required to make the fixing step easy. Further, the current collecting auxiliary member 54 has a simple construction which comprises the male lug 55 and the female lug 56, so that the current collecting auxiliary member 54 can easily be made, for example, from a metal piece by press work.

As described above, the secondary cell of the present invention is adapted to improve current collection efficiency without an increase in the number of electrode tabs.

### BRIEF DESCRIPTION OF THE DRAWINGS

FIG. 1 is a view in section of a lithium polymer secondary cell embodying the present invention;

FIG. 2 is an enlarged view in section of a current collecting auxiliary portion of the lithium polymer secondary cell;

FIG. 3 is a perspective view partly in development and showing a rolled-up electrode unit;

FIG. 4 is a perspective view of the rolled-up electrode unit;

FIG. 5 is a perspective view of the rolled-up electrode unit wrapped with a laminate sheet;

FIG. 6 is a perspective view partly in development and showing a rolled-up electrode unit having another construction;

FIG. 7 is a view in section of a current collecting auxiliary portion having another construction;

FIG. 8 is a view in section showing a state wherein a current collection auxiliary pin providing the current collecting auxiliary portion extends through a projection;

FIG. 9 is a view in section of a current collecting auxiliary portion having further another construction;

FIG. 10 is an enlarged view showing a state wherein a current collecting auxiliary member providing the current collecting auxiliary portion holds the projection;

FIG. 11 is a view in section of the conventional lithium polymer secondary cell;

FIG. 12 is a view in section of the lithium polymer secondary cell;

FIG. 13 is a perspective view partly in development and showing the conventional rolled-up electrode unit;

FIG. 14 is a perspective view partly in development and showing the conventional rolled-up electrode unit having another construction.

### DETAILED DESCRIPTION OF THE INVENTION

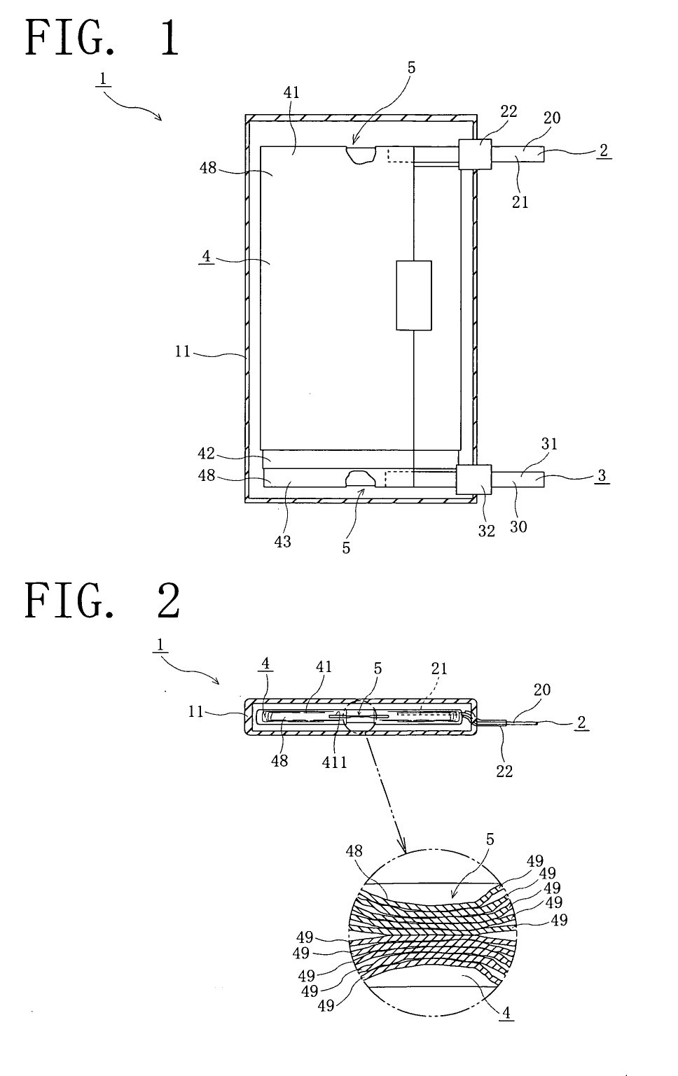

The present invention as applied to lithium polymer secondary cells will be described below with reference to the drawings. The lithium polymer secondary cell embodying the present invention, as shown in FIGS. 1 and 2, comprises an outer body 11 which is formed by a laminate sheet comprising two resin layers and an aluminum layer interposed between the resin layers, and a rolled-up electrode unit 4 which is accommodated into the outer body 11.

The rolled-up electrode unit 4 has a flat shape formed perpendicularly to its winding axis. Electrode tabs 2, 3 in the form of a strip are attached to the positive electrode 41 and the negative electrode 43 of the rolled-up electrode unit 4, respectively. Outer ends of the two electrode tabs 2, 3 project from the side portion of the outer body 11 to the outside. The outer ends form a pair of positive and negative electrode terminal portions 20, 30, through which power generated by the rolled-up electrode unit 4 is delivered to the outside.

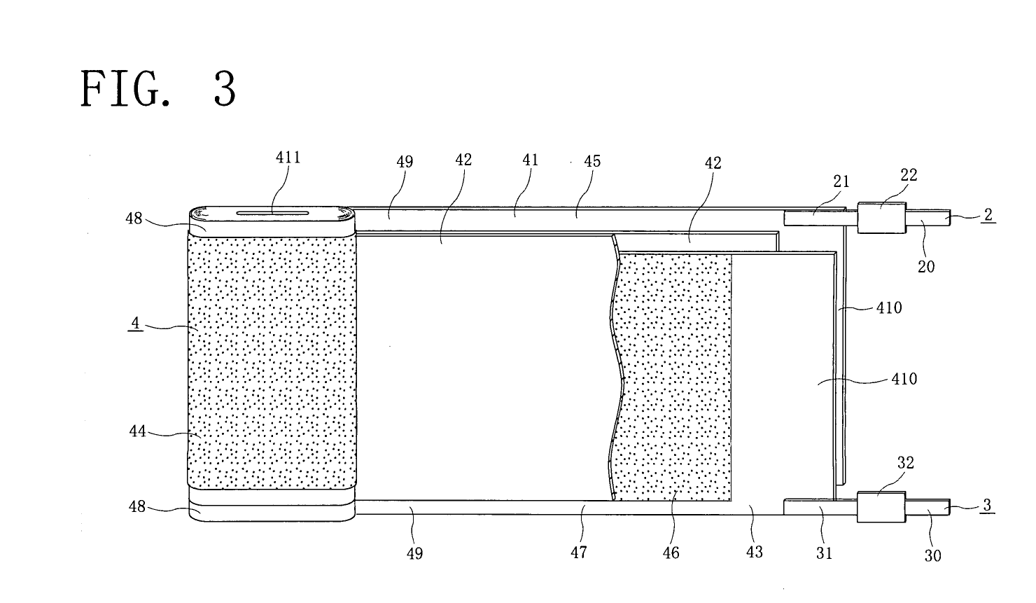

The rolled-up electrode unit 4 comprises the positive electrode 41 and the negative electrode 43 which are each in the form of a strip and which are rolled up into a spiral form with a separator 42 in the form of a strip interposed between the electrodes as shown in FIG. 3. The positive electrode 41 comprises a current collector 45 made of aluminum foil and in the form of a strip and coated over opposite surfaces thereof with a positive electrode active substance 44 comprising a lithium containing composite oxide. The negative electrode 43 comprises a current collector 47 made of copper foil and in the form of a strip and coated over opposite surfaces thereof with a negative electrode active substance 46 containing a carbon material. The separator 42 is impregnated with a gel electrolyte.

The positive electrode 41 is formed with a coated portion coated with the positive electrode active substance 44 and an uncoated portion not coated with the active substance 44. The uncoated portion includes an uncoated end portion 49 formed along an edge of the current collector 45, and an uncoated rolled-up portion 410 formed at an end extending longitudinally and to be rolled up lastly. Further the negative electrode 43 is formed with a coated portion coated with the negative electrode active substance 46 and an uncoated portion not coated with the active substance 46. The uncoated portion includes an uncoated end portion 49 formed along an edge of the current collector 47, and an uncoated rolled-up portion 410 formed at an end extending longitudinally and to be rolled up lastly.

The positive and negative electrodes 41, 43 are lapped over respective separators displaced from the separator 42 widthwise thereof. Each of the uncoated end portions 49 of the positive electrode 41 and the negative electrode 43 projects outward beyond the opposite edges of the separator 42. The electrodes and the separator which are thus lapped over are rolled up into a spiral form, and thereafter an outer peripheral surface of the electrode unit is compressed from opposite side portions, to thereby provide the rolled-up electrode unit 4 having a flat shape formed perpendicularly to the winding axis.

With the rolled-up electrode unit 4, a plurality of uncoated end portions 49 of the positive electrode 41 project outward beyond one edge of the separator 42 at one of the axially opposite ends of the electrode unit, to form a projection 48. A plurality of uncoated end portions 49 of the negative electrode 43 project outward beyond the other edge of the separator 42 at the other end of the opposite ends, to form a projection 48. Further the rolled-up electrode unit 4 is formed with a central hole 411 extending through the electrode unit 4 between the axially opposite ends thereof.

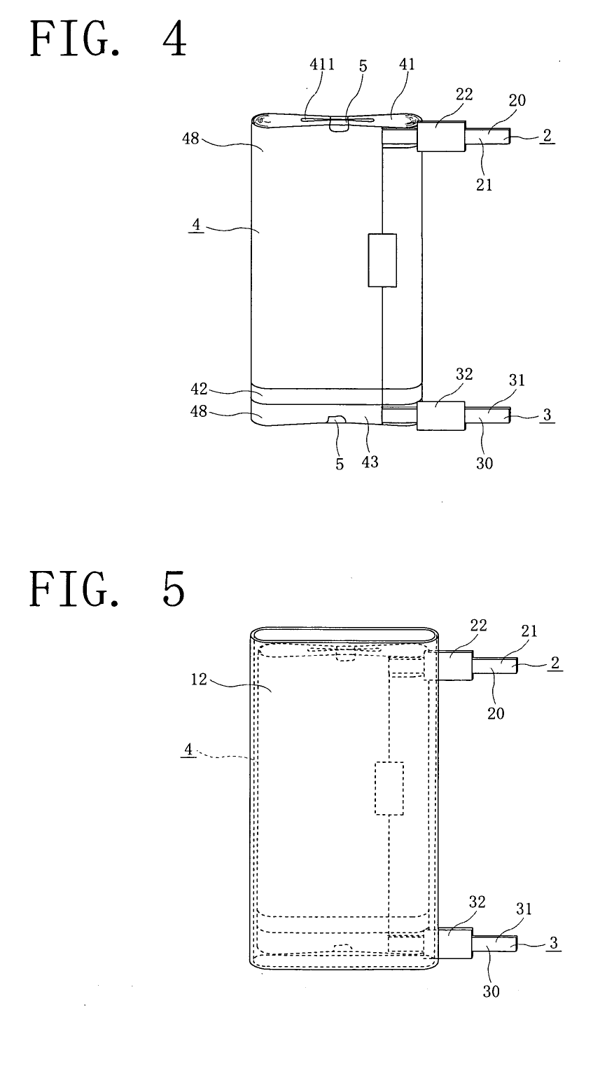

An electrode tab 2 of the positive electrode side is attached to the uncoated rolled-up portion 410 of the positive electrode 41 in a posture such that the tab projects perpendicularly to the winding axis of the rolled-up electrode unit 4. The electrode tab 2 includes a lead 21 in the form of a strip and a resin cover 22 for covering opposite surfaces of the central portion of the lead 21. A positive electrode terminal portion 20 is formed by an end of the lead 21. An electrode tab 3 of the negative side is attached to the uncoated rolled-up portion 410 of the negative electrode 43 in a posture such that the tab projects perpendicularly to the winding axis of the rolled-up electrode unit 4. The electrode tab 3 includes a lead 31 in the form of a strip and a resin cover 32 for covering opposite surfaces of the central portion of the lead 31. A negative electrode terminal portion 30 is formed by an end of the lead 31. Thus the pair of electrode terminal portions 20, 30 project sideward beyond the rolled-up electrode unit 4 as seen in FIG. 4.

Furthermore, the pair of electrode terminal portions 20, 30 project sideward beyond the rolled-up electrode unit 4. Alternatively, the pair of electrode terminal portions 20, 30 can project axially of the electrode unit 4 as shown in FIG. 6. The two electrode tabs 2, 3 are attached to the uncoated rolled-up portions 410, 410 of the positive electrode 41 and negative electrode 43 of the rolled-up electrode unit 4, respectively, as in the same manner.

Provided at the central portion of each projection 48 of the rolled-up electrode unit 4 is a current collecting auxiliary portion 5 formed by bringing each pair of the adjacent uncoated end portions 49, 49 into ultrasonic pressing contact with each other as seen FIG. 2, whereby each pair of the adjacent uncoated end portions 49, 49 is in pressing contact with each other.

Next, fabrication process of the lithium polymer secondary cell described will be described below.

[Preparation of Positive Electrode 41]

A positive electrode composition powder was prepared by mixing together LiCoO₂ and carbon in the ratio by mass of 92:5. 200 g of the positive electrode composition powder thus obtained was filled into a mixing apparatus (e.g., “Mechanofusion” fabricated by Hosokawa Micron). The mixing apparatus was operated at 1500 rpm for 10 minutes to subject the positive electrode composition powder to impact, compression, and shear to mix the resulting powder, thereby obtaining the mixed positive electrode active substance. Subsequently the mixed positive electrode active substance and a binder of polyvinylidene fluoride (PVDF) were mixed together in the ratio by mass of 97:3 in NMP solvent to obtain a positive electrode composition slurry, which was then applied to a coated portion of opposite surfaces of aluminum foil. The coated foil was thereafter dried and rolled to prepare a positive electrode.

The positive electrode is not limited to the structure above stated, but usable as the positive electrode composition powder are a lithium nickel composite oxide including lithium-nickel oxide, lithium-manganese composite oxide including spinel-type lithium-manganese oxide, or olivine-type phosphoric acid compound. Furthermore, usable as the positive electrode active substance is the positive electrode composition powder before mixing with the mixing apparatus.

[Preparation of Negative Electrode 43]

A negative electrode active substance was prepared by mixing graphite and styrene-butadiene rubber in the ratio by mass of 98:2. The negative electrode active substance thus obtained was applied to a coated portion of opposite surfaces of copper foil. The coated foil thereafter was dried and rolled to prepare a negative electrode. The negative electrode is not limited to the structure above stated, but usable as the negative electrode active substance are coke, tin oxide, metallic lithium, silicon or a mixture of these.

[Preparation of Gel Electrolyte]

Ethylene carbonate and diethyl carbonate were mixed together in the ratio by volume of 3:7 to obtain a solvent mixture, in which LiPF₆ was dissolved in the ratio of 1 mol/l to prepare an electrolyte. The electrolyte and lithium salt were mixed together in polymer to obtain a gel electrolyte.

The electrolyte is not limited to the structure above stated, usable as lithium salt are LiClO₄, LiN(SO₂CF₃)₂, LiN(SO₂C₂F₅)₂, LiPF₆₋ₓ(CₙF₂ₙ₊₁)ₓ wherein 1≦x<6, n=1 or 2, or a mixture of several of these. Lithium salt concentration is preferably in the range of 0.8 mol/l to 1.5 mol/l. Examples of solvents are preferably carbonate solvents including EC, PC, GBL, EMC, and DMC, and are further preferably combinations of cyclic carbonate and chain-carbonate.

Examples of polymer materials are preferably polyether solid polymer, polycarbonate solid polymer, polyacrylonitrile solid polymer, oxetane polymer, epoxy polymer, and copolymer or cross-linked polymer of two or more kinds of these.

[Assembly of Cell]

When outer ends of the two electrode tabs 2, 3 project from ends longitudinally of the positive and negative electrodes 41, 43, respectively, base ends of the two electrode tabs 2, 3 were respectively brought into ultrasonic pressing contact with uncoated rolled-up portions 410, 410, to thereby connect the electrode tabs 2, 3 to the positive electrode 41 and the negative electrode 43, respectively, as seen in FIG. 3. An ion-permeable finely porous membrane of polypropylene serving as a separator 42 was wound around a spool (not shown) several turns, and thereafter four sheets i.e., a sheet of the positive electrode 41, the separator 42, a sheet of the negative electrode 43 and the separator 42, were placed one over another in superposed layers so as to interpose the separator 42 between the positive and negative electrodes 41, 43. In this state, the positive electrode 41, the negative electrode 43, and the separators were wound up from the end portion which is opposite to the uncoated rolled-up portions 410, 410 into a spiral form to prepare a cylindrical rolled-up electrode unit.

Subsequently, the spool was removed, and thereafter the rolled-up electrode unit was compressed to obtain the rolled-up electrode unit 4 having a flat shape formed perpendicularly to its winding axis, as shown in FIG. 4. Projections 48, 48 formed at the axially opposite ends of the electrode unit 4 were subjected to ultrasonic pressing to join to each other each pair of the uncoated end portions 49 providing each of the projections 48 to thereby form a current collecting auxiliary portion 5.

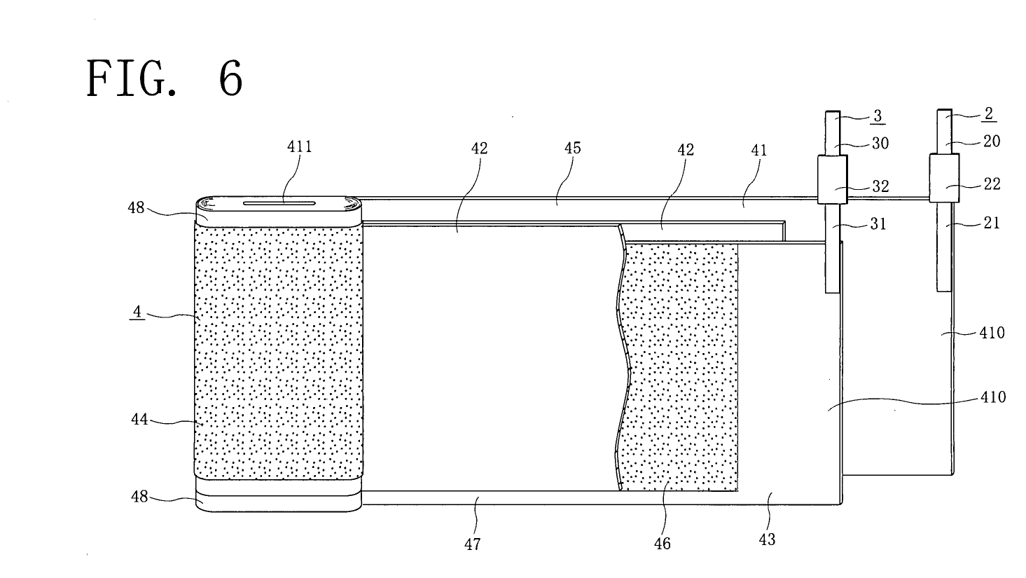

As shown in FIG. 5, a laminate sheet 12 in the form of a strip and comprising two resin layers and an aluminum layer interposed between the resin layers was folded in half, to accommodate the rolled-up electrode unit 4 into the folded laminate sheet, to seal off opposed overlap surfaces, respectively, provided at three sides of the folded laminate sheet 12. At this time the rolled-up electrode unit 4 was accommodated in a posture such that the electrode tabs 2, 3 extend through the opposed overlap surface provided at the central side, and the opposed overlap surface provided at the central side and another opposed overlap surface provided at another side were sealed off, respectively. For sealing off the opposed overlap surface provided at the central side from which the two electrode tabs 2, 3 project, the laminate sheet 12 was superposed on resin covers 22, 32, and the resin covers 22, 32 was welded to a resin layer of the laminate sheet 12. Consequently, the laminate sheet 12 was formed into a bag-shape having an opening.

The gel electrolyte was thereafter poured into the opening. At an end portion of the rolled-up electrode unit 4, a clearance was formed between the separator 42 and one of the positive and negative electrodes 41, 43. The clearance had an opening axially of the rolled-up electrode unit 4, so that the gel electrolyte can easily penetrate into the rolled-up electrode unit 4 to impregnate the rolled-up electrode unit 4, in its entirety, with the gel electrolyte in a short period of time. As a last step, the opening was sealed off, to complete the preparation of the lithium polymer secondary cell of the present embodiment and having a capacity of 3000 mA.

With the lithium polymer secondary cell of the present invention, current generated in the rolled-up electrode unit 4 flows to the electrode tab via a first current path which does not pass through the current collecting auxiliary portion 5 and a second current path which passes through the current collecting auxiliary portion 5. In this case, almost all of current generated in an area far from the electrode tab will flow to the electrode tab via the second current path having low electric resistance because the second current path becomes extremely shorter than the first current path. On the other hand, almost all of current generated in an area near the electrode tab will flow to the electrode tab via the first current path having low electric resistance because the first current path becomes shorter than the second current path.

Accordingly, the current generated in the rolled-up electrode unit 4 will flow to the electrode tab via one of the current paths which has lower electric resistance depending on a position at which the current was generated. Therefore, the current path of the rolled-up electrode unit 4 in its entirety has lower electric resistance than that of the conventional secondary cell wherein one current path corresponding to the first current path is merely provided. Additionally, the current collecting auxiliary portion 5 was formed by bringing each pair of the adjacent uncoated end portions 49, 49 into ultrasonic pressing contact with each other and joining to each other each pair of the portions 49, 49, whereby the current collecting auxiliary portion 5 has extremely low electric resistance.

As stated above, with the lithium polymer secondary cell of the present invention, each of the positive electrode 41 and the negative electrode 43 of the rolled-up electrode unit 4 is provided with one electrode tab. However, the formation of the current collecting auxiliary portion 5 reduces the electric resistance of the current path to reduce internal resistance of the cell to achieve high current collection efficiency.

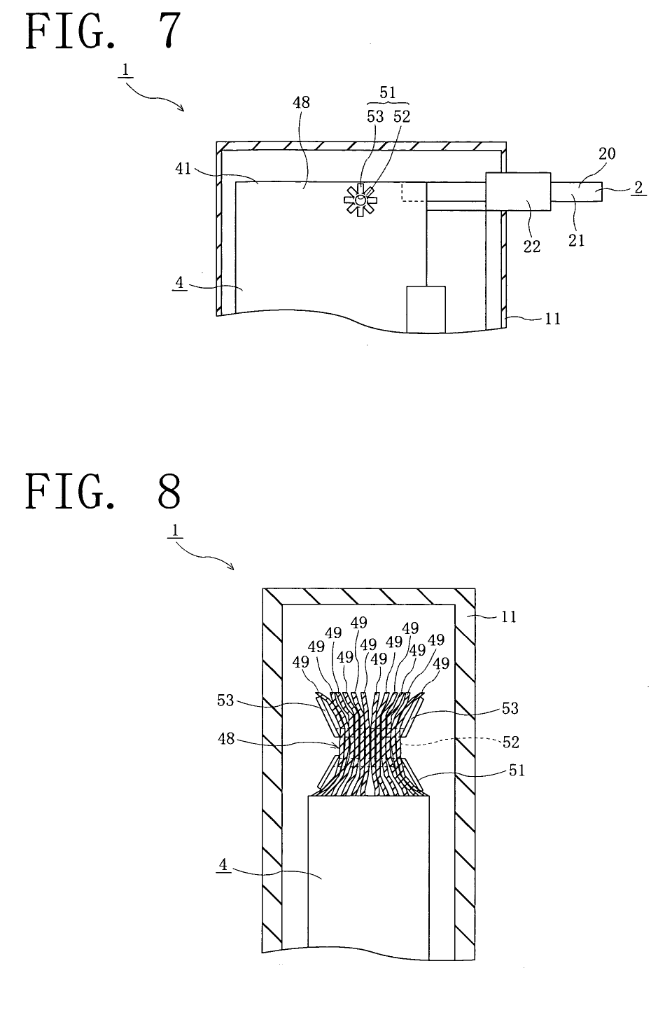

With the lithium polymer secondary cell of the present invention, the current collecting auxiliary portion 5 described above can be replaced by a current collection auxiliary pin 51 extending through the projection 48 as seen in FIGS. 7 and 8. The current collection auxiliary pin 51 comprises a cylindrical barrel portion 52 and a pair of pressing portions 53, 53 including a plurality of ridges extending radially from opposite ends of the barrel portion 52. The barrel portion 52 extends through a central portion of the projection 48 of the rolled-up electrode unit 4. The pair of pressing portions 53, 53 hold the projection 48 by pressure between its opposite sides. This applies a great pressing force to a plurality of uncoated end portions 49, and each pair of the adjacent uncoated end portions 49, 49 is therefore in pressing contact with each other over a large area of contact.

Accordingly, with the current collecting auxiliary portion 5, electric resistance is reduced over the surface of contact of each pair of the adjacent uncoated end portions 49, 49. The current collection auxiliary pin 51 is fixed to the projection 48 by crimping, so that there is no likelihood that the current collection auxiliary pin 51 will be removed from the projection 48 even when a great impact is applied thereto from the outside, to reliably ensure the state wherein each pair of the adjacent uncoated end portions 49, 49 is held in pressing contact with each other.

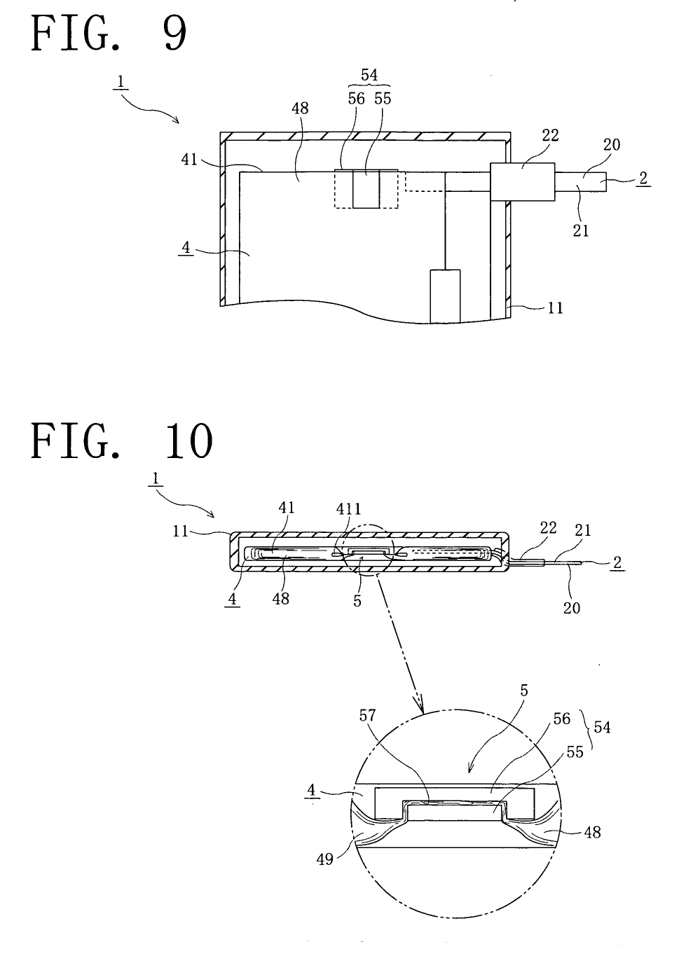

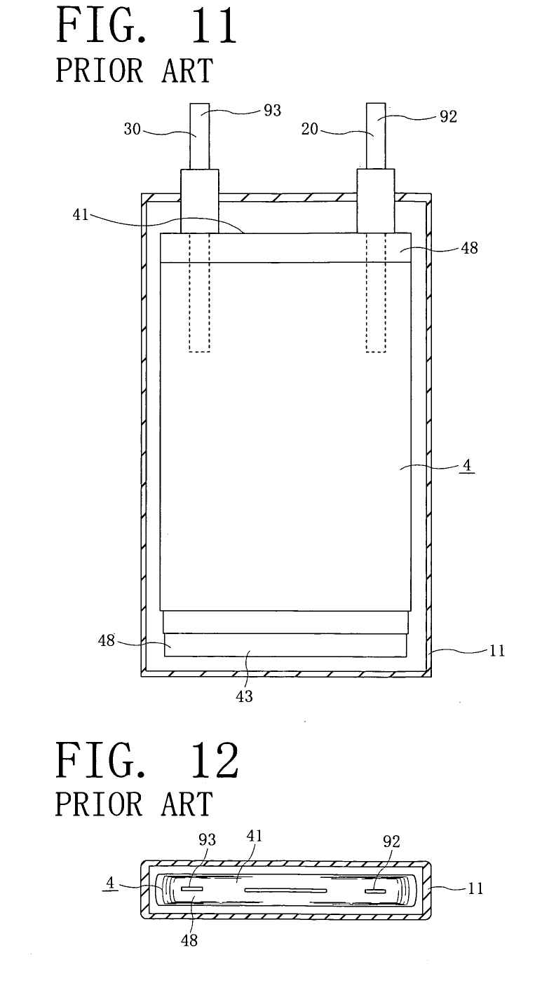

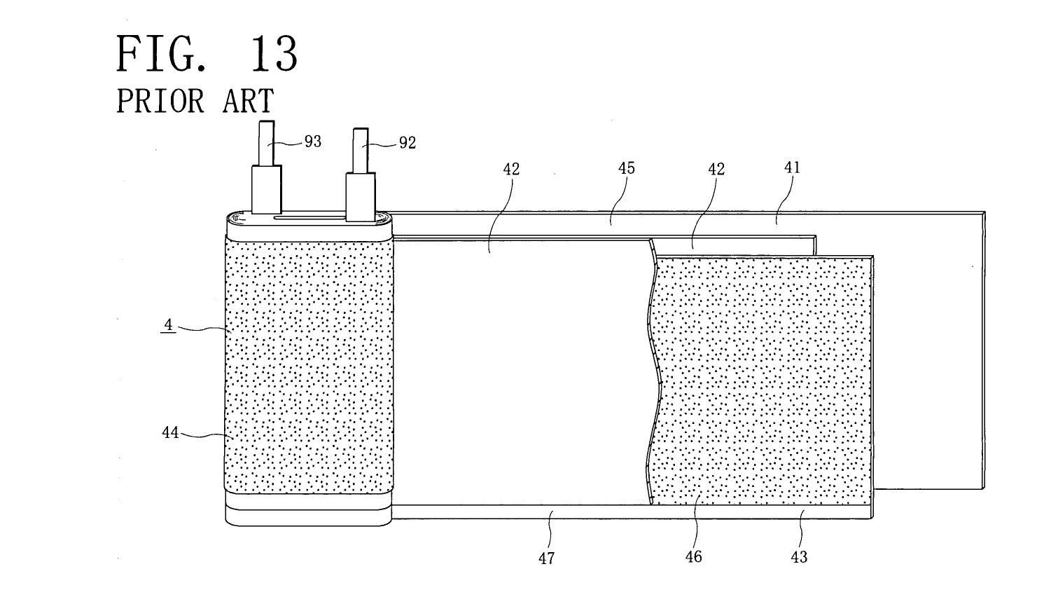

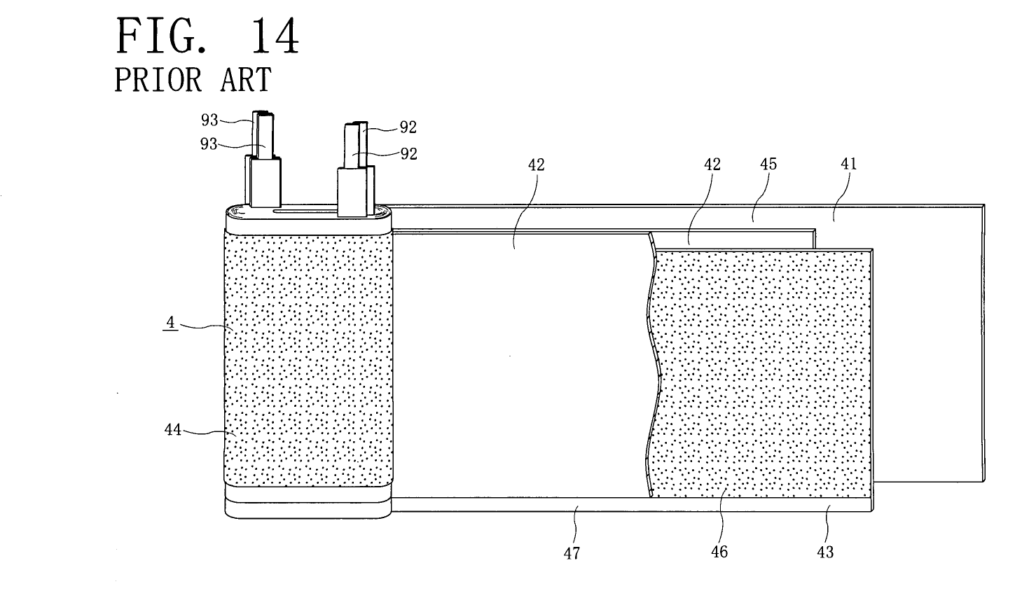

With the lithium polymer secondary cell of the present invention, the construction of the current collecting auxiliary portion 5 described above can be replaced by a current collecting auxiliary member 54 for holding the projection 48 between its opposite sides as shown in FIGS. 9 and 10. The current collecting auxiliary member 54 comprises a male lug 55 in the form of a flat plate and a female lug 56 having a recess portion 57 into which the male lug 55 is fitted. The male lug 55 is fitted into the recess portion 57 of the female lug 56 with the projection 48 of the rolled-up electrode unit 4 interposed therebetween, with the result that a great pressing force is applied to the plurality of uncoated end portions 49 and each pair of the adjacent uncoated end portions 49, 49 is therefore in pressing contact with each other over a large area of contact.

Accordingly, with the above auxiliary current collecting portion 5, electric resistance is reduced over the surface of contact of each pair of the adjacent uncoated end portions 49, 49. Further, the current collecting auxiliary member 54 can be easily made from a metal piece by press work, and additionally, can be fixed by fitting the male lug 55 into the recess portion 57 of the female lug 56. Therefore the fixing step of the current collecting auxiliary portion 5 is easy.

A plurality of embodiment cells and comparative cells were fabricated, respectively to substantiate the advantage of the present invention. In fabricating a first comparative cell, first a positive electrode and a negative electrode each having one electrode tab attached thereto and which were each in the form of a strip were rolled up into a spiral form with a separator interposed between the electrodes to prepare a rolled-up electrode unit. Next a laminate sheet comprising two resin layers and an aluminum layer interposed between the resin layers was folded in half, to accommodate the rolled-up electrode unit into the folded laminate sheet, to seal off each of opposed overlap surfaces provided at three sides of the folded laminate sheet except for the opposed overlap surface serving as an opening into which electrolyte is poured. Gel electrolyte was poured into the opening, and thereafter the opening was sealed off to thereby obtain a first comparative cell comprising an outer body made of the laminate sheet and the rolled-up electrode unit accommodated into the outer body. A projection comprising an uncoated portion was not formed at opposite ends of the electrode unit of the comparative cell.

In fabricating a second comparative cell, ten layers of negative electrodes and nine layers of positive electrodes were superposed in an order of a negative electrode, separator, positive electrode, and separator as placed one over another so that the separator was interposed between the positive electrode and the negative electrode which each comprised one electrode tab and which were each in the form of a sheet, to prepare an electrode unit of superposed-layers type. Next, a laminate sheet comprising two resin layers and an aluminum layer interposed between the resin layers was folded in half, to accommodate the electrode unit of superposed-layers type into the folded laminate sheet, to seal off each of opposed overlap surfaces provided at three sides of the folded laminate sheet except for the opposed overlap surface serving as an opening into which electrolyte is poured. Gel electrolyte was poured into the opening, and thereafter the opening was sealed off to thereby obtain a second comparative cell comprising an outer body made of the laminate sheet and the electrode unit of superposed-layers type accommodated into the outer body.

A lithium polymer secondary cell (First embodiment cell) shown in FIG. 1, and a lithium polymer secondary cell (Second embodiment cell) shown in FIG. 6 which had the two electrode tabs projecting beyond one end portion axially of the rolled-up electrode unit were prepared by the fabrication process of the present embodiment described above. Each cell was coated with the active substance in the same amount: 340 mg/10 cm² was used as to the positive electrode, 160 mg/10 cm² was used as to the negative electrode. Each cell had the same coating area, 1360 cm². The number of turns in the rolled-up electrode unit was ten for the first comparative cell, the first embodiment cell, and the second embodiment cell.

Table 1 shows the test results of the internal resistance of the cells.

TABLE 1

| fabricated | 1^{st} | 2^{nd} | 1^{st} | 2^{nd} |
|---|---|---|---|---|
| cell | compara. cell | compara. cell | embodi. cell | embodi. cell |
| type | rolled-up | superposed | rolled-up | rolled-up |
| | | layers | | |
| Internal | 33 mΩ | 14 mΩ | 15 mΩ | 15 mΩ |
| resist. | | | | |

Table 1 indicates that the first embodiment cell and the second embodiment cell exhibit reduced internal resistance values as small values as those of the second comparative cell of superposed-layers type and which had a plurality of electrode tabs. This result substantiates the advantage of the formation of the current collecting auxiliary portion for reducing the internal resistance.

Subsequently the first comparative cell and the first embodiment cell varied in electrode length of the positive and negative electrodes, respectively, and were checked for the internal resistance at each electrode length. Table 2 shows the test result. The coated length widthwise of the coated portion formed at the pair of electrodes is 50 mm, respectively.

TABLE 2

| | electrode length (mm) | | | | |
|---|---|---|---|---|---|
| | 400 | 500 | 600 | 800 | 1000 |
| Internal | 65 mΩ | 46 mΩ | 38 mΩ | 35 mΩ | 28 mΩ |
| resistance of | | | | | |
| 1^{st} compara. cell | | | | | |
| Internal | 65 mΩ | 46 mΩ | 30 mΩ | 22 mΩ | 17 mΩ |
| resistance of | | | | | |
| 1^{st} embodi. cell | | | | | |

Table 2 reveals that the difference in internal resistance between the first comparative cell and the first embodiment cell increases with the electrode length. When the electrode length is greater than 600 mm, the difference in internal resistance between the first comparative cell and the first embodiment cell becomes noticeable. Consequently the current collecting auxiliary portion exhibits its advantage effectively when the electrode length is 600 mm or more.

Furthermore, the first comparative cell and the first embodiment cell varied in area coated with the active substance of the positive and negative electrodes, respectively, and were checked for the internal resistance at each value of area coated with the active substance. Table 3 shows the test result. The coated length widthwise of the coated portion formed at the pair of electrodes is 50 mm, respectively.

TABLE 3

| | coated area (cm²) | | | | |
|---|---|---|---|---|---|
| | 500 | 600 | 700 | 800 | 900 |
| Internal | 43 mΩ | 40 mΩ | 36 mΩ | 34 mΩ | 27 mΩ |
| resistance of | | | | | |
| 1^{st} compara. cell | | | | | |
| Internal | 43 mΩ | 39 mΩ | 29 mΩ | 21 mΩ | 13 mΩ |
| resistance of | | | | | |
| 1^{st} embodi. cell | | | | | |

Table 3 reveals that the difference in internal resistance between the first comparative cell and the first embodiment cell increases with the area coated with the active substance of the pair of electrodes. When the area coated with the active substance is greater than 700 cm², the difference in internal resistance between the first comparative cell and the first embodiment cell becomes noticeable. Consequently the current collecting auxiliary portion exhibits its advantage effectively when the area coated with the active substance is 700 cm² or more.

The device of the invention is not limited to the foregoing embodiments in construction but can be modified variously within the technical scope set forth in the appended claims. For example, the same advantage as the foregoing embodiments is available by a current collecting auxiliary portion 5 formed by subjecting the projection 48 of the rolled-up electrode unit 4 to welding to join to each pair of the uncoated end portions 49 providing the projection 48. Further the same advantage as the foregoing embodiment is also available by a current collecting auxiliary portion 5 wherein an auxiliary current collection clip including a pair of side plates for performing elastic restoring force to each other in close proximity clamps the projection 48 therebetween to thereby bring each pair of the adjacent uncoated end portions 49, 49 into pressing contact with each other.

1. A secondary cell having a rolled-up electrode unit 4 comprising a positive electrode 41 and negative electrode 43 which are each in the form of a strip and which are rolled up into a spiral form with a separator 42 interposed between the electrodes, the rolled-up electrode unit 4 being accommodated into an outer body 11, the positive electrode 41 and the negative electrode 43 each comprising a current collector in the form of a strip and an active substance applied to a surface of the current collector, the rolled-up electrode unit 4 generating power to be delivered to the outside via a pair of positive and negative electrode terminal portions 20, 30,
wherein each of the positive electrode and the negative electrode has an uncoated portion which is not coated with the active substance and which is formed at one of axially opposite ends of the electrode unit and which is formed along an edge of the current collector, the rolled-up electrode unit 4 having a projection 48 at one end of the axially opposite ends of the electrode unit and which is formed by the uncoated portion of the positive electrode projecting therefrom, the rolled-up electrode unit 4 having a projection 48 at the other end and which is formed by the uncoated portion of the negative electrode projecting therefrom, each of the projections 48 being provided with a current collecting auxiliary portion 5 formed by joining to each other each of the adjacent uncoated portions, the rolled-up electrode unit 4 comprising a pair of electrode tabs 2, 3 each in the form of a strip, a base end of the electrode tab 2 being connected to the positive electrode 41 while a base end of the electrode tab 3 being connected to the negative electrode 43, a pair of outer end portions of the electrode tabs 2, 3 extending to the outside through the outer body 11, and the pair of outer end portions forming a pair of positive and negative electrode terminal portions 20, 30, respectively.

2. A secondary cell according to claim 1, wherein the rolled-up electrode unit 4 has a flat shape formed perpendicularly to its winding axis, the outer body 11 being formed by a laminate sheet comprising two resin layers and a metal layer interposed between the resin layers, each of the positive electrode 41 and the negative electrode 43 being formed with an uncoated rolled-up portion 410 not coated with the active substance at an end portion longitudinally of the current collector, the electrode tab having its base end connected to the uncoated rolled-up portion 410 and projecting perpendicularly to the winding axis of the rolled-up electrode unit 4.

3. A secondary cell according to claim 1, wherein the rolled-up electrode unit 4 has a flat shape formed perpendicularly to its winding axis, the outer body 11 being formed by a laminate sheet comprising two resin layers and a metal layer interposed between the resin layers, each of the positive electrode 41 and the negative electrode 43 being formed with an uncoated rolled-up portion 410 not coated with the active substance at an end portion longitudinally of the current collector, the electrode tab having its base end connected to the uncoated rolled-up portion 410 and projecting parallel to the winding axis of the rolled-up electrode unit 4.

4. A secondary cell according to claim 1, wherein the current collecting auxiliary portion 5 is formed by bringing each pair of the adjacent uncoated portions into ultrasonic pressing contact with each other.

5. A secondary cell according to claim 1, wherein the current collecting auxiliary portion 5 comprises a current collection auxiliary pin 51 extending through the projection 48 of the rolled-up electrode unit 4, the current collection auxiliary pin 51 comprising a barrel portion 52 extending through the projection 48 and a pair of pressing portions 53, 53 projecting from opposite ends of the barrel portion 52, the pair of pressing portions 53, 53 holding the projection 48 by pressure between its opposite sides, the holding pressure allowing each pair of the adjacent uncoated portions to be in pressing contact with each other.

6. A secondary cell according to claim 1, wherein the current collecting auxiliary portion 5 comprises a current collecting auxiliary member 54 for holding the projection 48 of the rolled-up electrode unit 4 between its opposite sides, the current collecting auxiliary member 54 comprising a male lug 55 and a female lug 56 which are fittable to each other with the projection 48 interposed therebetween, the pressing force applied by the male lug 55 and the female lug 56 causing each pair of the adjacent uncoated portions to be in pressing contact with each other.
